(19) United States
(12) Patent Application Publication
(10) Pub. No.: US 2005/0224404 A1
(43) Pub. Date: Oct. 13, 2005

(54) Closed end reverse osmosis unit

(76) Inventor: Dennis Chancellor, Gilbert, AZ (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/078,819

(22) Filed: Mar. 10, 2005

Related U.S. Application Data
(60) Provisional application No. 60/552,298, filed on Mar. 10, 2004.

(51) Int. Cl. B01D 63/00

(52) U.S. Cl. 210/321.6; 210/445; 210/450

(57) ABSTRACT

A closed reverse osmosis system comprises an end cap that has a pressure vessel portion adapted to inhibit flow of feed fluid, a permeate fluid conduit that extends from a permeate fluid flow path, and a waste fluid chamber that extends from a waste fluid flow path.

This application claims the benefit of U.S. provisional application No. 60/552298 filed on Mar. 10, 2004 incorporated herein by reference in its entirety.

### FIELD OF THE INVENTION

The field of the invention is filtration systems.

### BACKGROUND OF THE INVENTION

Filtration systems that use a plurality of serially arranged filters in a single housing typically terminate without regard to the pre-established flow paths for waste fluid (i.e. fluid that has passed through a membrane but not been filtered into the permeate), permeate (i.e. clean or filtered fluid), and bypass fluid (i.e. fluid that has not entered a membrane at all). Such systems are therefore not susceptible to being coupled in series and additionally do not terminate in a way that keeps all three types of fluid separated.

Thus, there is a need to a specialized end cap which provides for separate chambers for waste fluid, permeate, and bypass fluid.

### SUMMARY OF THE INVENTION

The present invention is directed to an end cap for a filtration system having multiple filters arranged serially and having distinct flow paths for feed fluid, waste fluid, and permeate. The end cap comprises a pressure vessel cap portion adapted to inhibit flow of feed fluid, a permeate chamber adapted to extend from the permeate flow path, and a waste fluid chamber adapted to extend from the waste fluid flow path.

In another aspect, a rreverse osmosis (RO) water filtrations system has a specialized end cap having outer, intermediate, and central chambers. The outer chamber prevents feed water from flowing through the downstream end of the last downstream filter. The intermediate and central chambers transport reject water and permeate, respectively.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a cutaway view of a filtration system embodying the invention.

FIG. 2 is a cutaway view of a filtration system embodying the invention.

FIG. 3 is a cutaway view of a filtration system embodying the invention.

FIG. 4 is a cutaway view of a filtration system embodying the invention.

### DETAILED DESCRIPTION

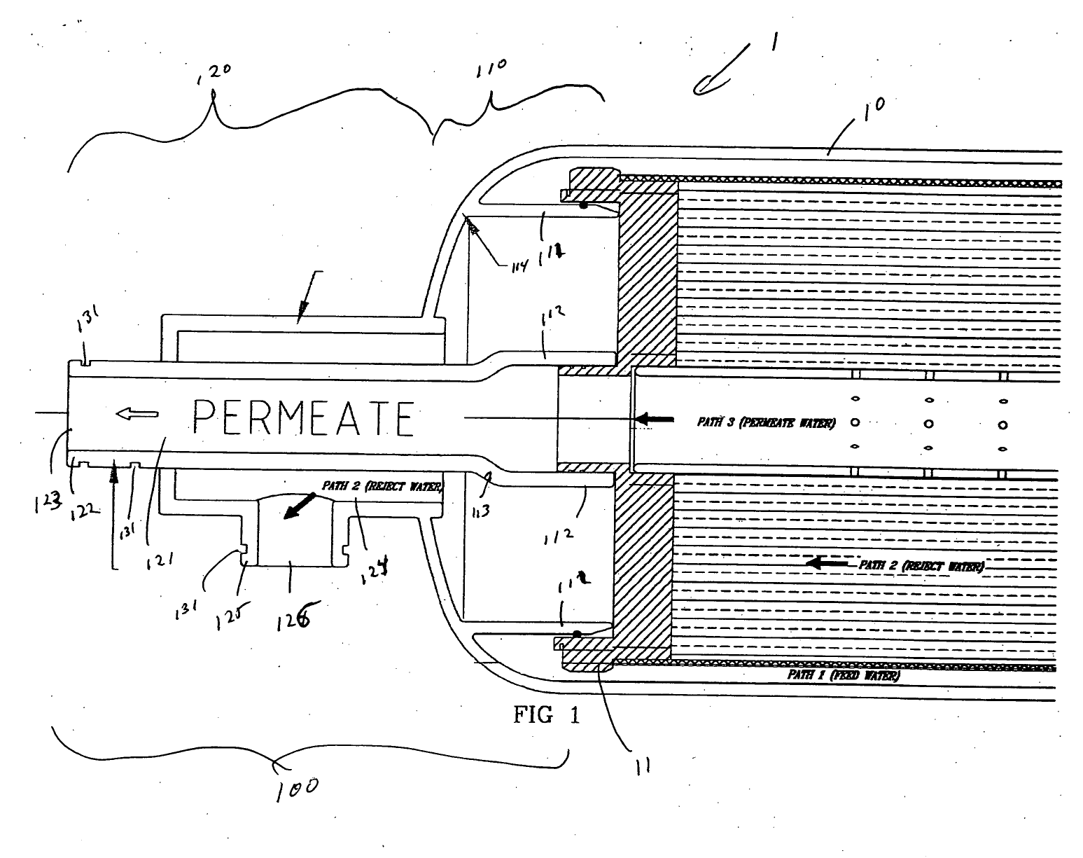

Referring first to FIG. 1, a filtration system 1 generally comprises a filtration vessel 10 that includes various membrane units, conduits, and interconnects to form at least three flow paths; one path for feed water, one for permeate, and one for reject water. Vessel 10 has an end cap 100 with a pressure vessel (PV) cap portion 110, and a permeate and reject conduit (PRC) portion 120. Of course, the term “water” is employed euphemistically herein to mean any suitable fluid being filtered.

A preferred cap is somewhat frustoconical, having a cone-shaped portion coupled to a cylindrical portion. PV cap portion 110 has a reject water flange 111, and/or a permeate flange 112. Flange 112 may be a different diameter than outlet 123, in which case a taper 113 may be used to adjust the diameter of the permeate flow path.

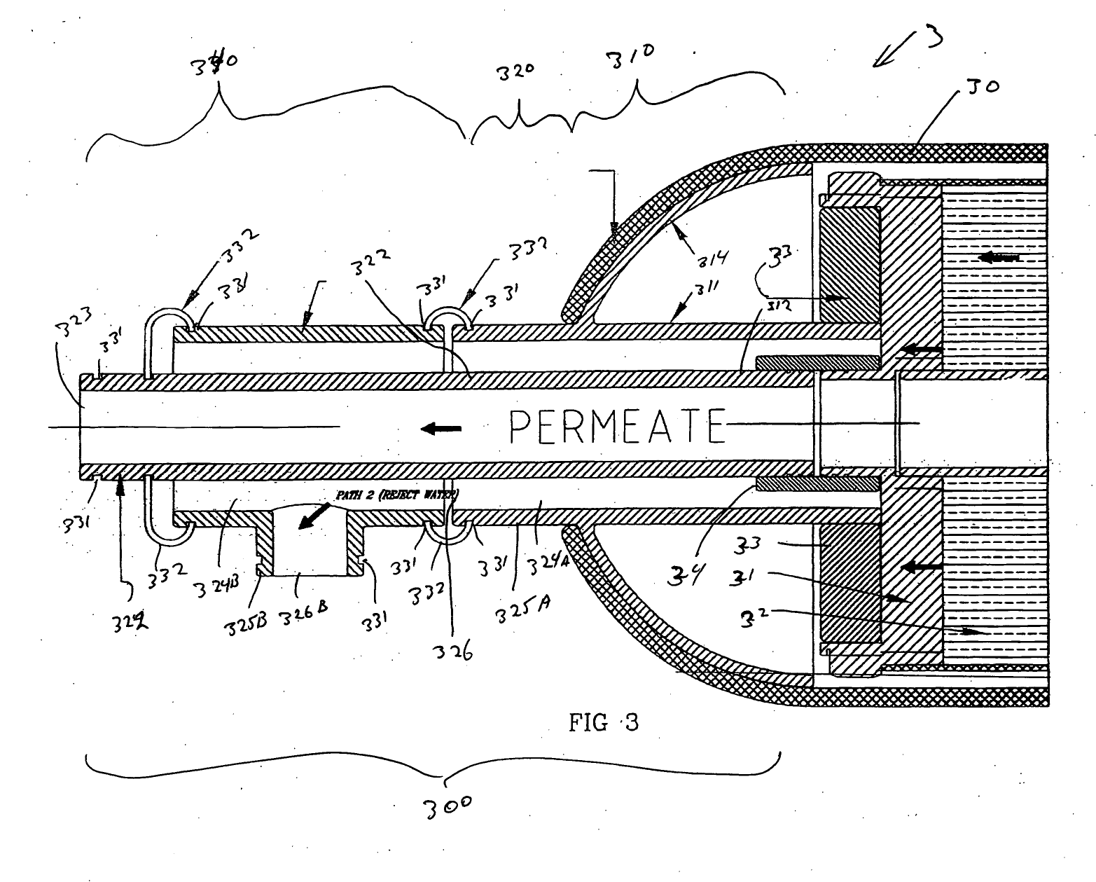

Conduit cap portion 120 will typically comprise a permeate conduit 121 that ends in a permeate outlet flange 122 disposed around permeate outlet 123. In addition, a preferred conduit cap has a reject water conduit 124 ending in a reject water outlet flange 125 disposed around reject water outlet 126. Flanges 122 and 125 preferably comprise one or more grooves 131 suitable for use with a Vitaulic™ type fitting 132 as can be observed from FIG. 3.

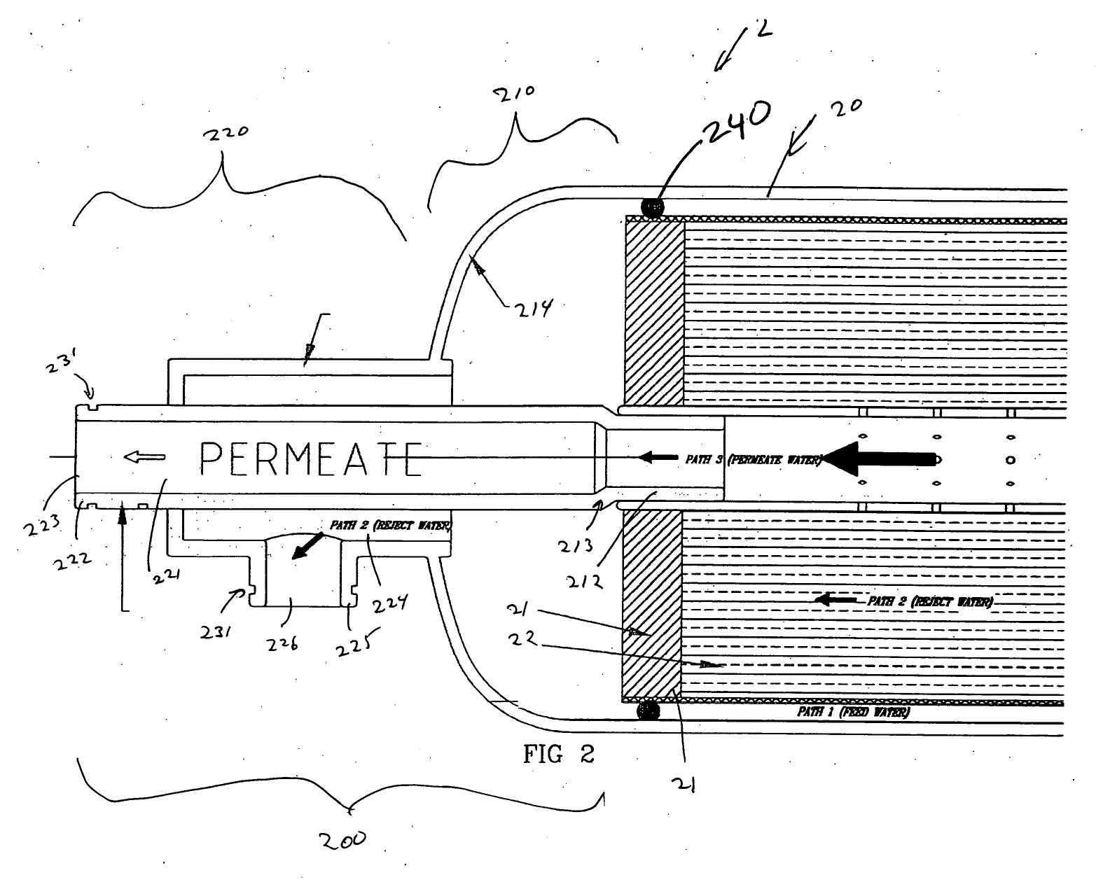

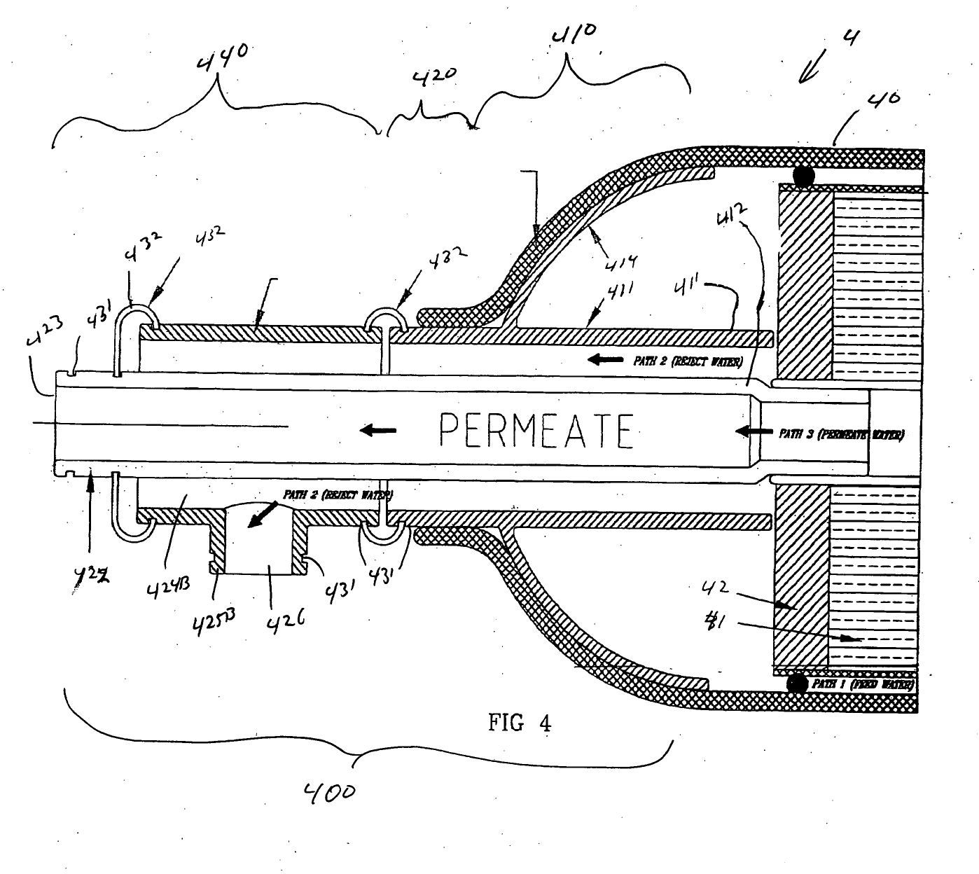

End caps may either be formed as integral parts of the corresponding pressure vessels as shown in FIGS. 1 and 2, or as separate units as shown in FIGS. 3 and 4. In either instance, the cap preferably has a curved surface that comprises the “end” of the pressure vessel, or that mates with the end of the pressure vessel. If the end cap is a separate unit means should be provided for coupling the end cap to the vessel. It will be appreciated that various means can be employed for coupling the end cap so long as the fluid flow paths are remain substantially sealed. The flanges of cap portion 110 are adapted to mate with corresponding portions of the permeate and reject water flow path members. In FIG. 1, flanges 111 and 112 mate with corresponding portions of interconnect 11 such that the reject water flow path 2 continues through cap 100, as does permeate water flow path 3, while feed water flow path 1 is stopped from by the outer chamber.

Permeate conduit 121 may comprise the same, a larger, or a smaller cross sectional area as the permeate flow path through pressure vessel 10. Reject water flow path is preferred to have a smaller cross sectional area at outlet 126 than at flange 111 so as to increase the back pressure in vessel 10 such that sufficient pressure exists to force water through the membrane filters. However, alternative embodiments may utilize reject water outlets having equal or larger cross sectional areas if other mechanisms are used to maintain the necessary pressure in vessel 10.

Outlet 126 is preferred to be perpendicular to outlet 131 for ease of coupling extensions or other components to PRC portion 120. In some instances PRC portion 120 may be supplemented by another fitting to form a third portion 340 and 440 of the cap as shown in FIGS. 3 and 4, respectively. In such instances it is preferred that the supplemented portion be coupled to the previous portion via one or more Vitaulic™ fittings (332, 432).

Drawing your attention to FIG. 2, filtration system 2 comprises filtration vessel 20 that includes various membrane units including membrane 22, conduits, and interconnects to form at least three flow paths, with one path being for feed water, one for permeate, and one for reject water.

Vessel 20 has an end cap 200 with a pressure vessel (PV) cap portion 210 and a permeate and reject conduit (PRC) portion 220. Cap portion 210 comprises a permeate flange 212, but not a reject water flange since such a flange is made unnecessary by blocking/closure of feed water feed path 1 upstream of cap 200 by o-ring 240. Flange 212 may be a different diameter than outlet 223, in which case a taper 213 may be used to adjust the diameter of the permeate flow path.

Conduit portion 220 comprises a permeate conduit 221 extending from a permeate feed path and ending in a permeate outlet flange 222 disposed around permeate outlet 223. Conduit portion 220 also comprises a reject water conduit 224 extending from a reject water (i.e. waste fluid) flow path and ending in a reject water outlet flange 225 disposed around reject water outlet 226. Flanges 222 and 225 preferably comprise one or more grooves 231 suitable for use with a Vitaulic™ type fitting 232.

In FIG. 3, a filtration system comprises filtration vessel 30 that includes various membrane units, conduits, and interconnects to form at least three flow paths, with one path being for feed water, one for permeate, and one for reject water.

Vessel 30 comprises an end cap 300 that has a pressure vessel (PV) cap portion 310 and a permeate and reject conduit (PRC) portion 320. Cap portion 310 also comprises a reject water flange 311, and/or a permeate flange 312. Conduit portion 320 has a permeate conduit 321 extending from the permeate flow path and ending in a permeate outlet flange 322 that encloses permeate outlet 323. Reject water conduit 324 extends from the reject water flow path and ends in a reject water outlet flange 325 that encloses reject water outlet 326.

Flanges 322 and 325 again preferably comprise one or more grooves 331 suitable for use with a Vitaulic™ type fitting 332 or other fitting that is capable of holding the components together. In addition, it should be pointed out that regardless of the type of fitting used, the fitting should form a fluid permeable seal.

End cap 300 differs from end caps 100 and 200 in that the reject water conduit comprises two segments 325A and 325B, with portion 340 of cap 300 being coupled to flange 325A such that the reject water flow path comprises segment 325A and 325B. Fitting 34 is used to couple permeate flow path 323 to that of vessel 30 as flange 312 neither encloses nor fits inside a mating permeate flange in vessel 30.

The system 4 of FIG. 4 is similar to the systems of FIGS. 1, 2, and 3, with a filtration vessel 40 that includes various membrane units, conduits, and interconnects to form at least three flow paths, where one path carries feed water, another carries permeate, and the third carries reject water.

Vessel 40 comprises an end cap 400 with a pressure vessel (PV) cap portion 410 and a permeate and reject conduit (PRC) portion 420. Cap portion 410 has a reject water flange 411, and/or a permeate flange 412. Flange 412 may be a different diameter than outlet 423 in which case a taper 413 may be used to adjust the diameter of the permeate flow path. Conduit portion 420 typically comprises a permeate conduit 421 extending from a permeate flow path and ending in a permeate outlet flange 422 disposed around permeate outlet 423. Conduit portion 420 also comprises a reject water conduit 424 extending from a reject fluid flow path and ending in a reject water outlet flange 425 disposed around reject water outlet 426.

Flanges 422 and 425 preferably comprise one or more grooves 431 suitable for use with a Vitaulic™ type fitting 432. As with cap 300, cap 400 differs from end caps 100 and 200 in that the reject water conduit comprises two pieces 425A and 425B with portion 440 of cap 400 being coupled to flange 425A such that the reject water flow path comprises segment 425A and 425B.

It should be noted that in a particular class of embodiments, the end caps detachable from the end of the pressure vessel. In such instances, replacement of the filter unit or units near the end cap is facilitated, particular for treatment system having filter units that are readily moveable within the pressure vessel.

Thus, specific embodiments and applications of a closed end reverse osmosis system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An end cap for a filtration system comprising:
a pressure vessel cap portion adapted to inhibit flow of feed fluid;
a permeate fluid chamber that extends from a permeate fluid flow path; and
a waste fluid chamber that extends from a waste fluid flow path.

2. The cap of claim 1, wherein the pressure vessel cap portion comprises a waste fluid flange that at least partially directs waste fluid into the waste fluid chamber.

3. The cap of claim 2, wherein the pressure vessel cap further comprises a permeate flange that at least partially directs permeate into the permeate chamber.

4. The cap of claim 3, wherein both the permeate flange and the waste fluid flange have grooves adapted to accept a Vitaulic™ fitting.

5. The cap of claim 1, further comprising an o-ring that substantially inhibits flow of the feed fluid.

6. The cap of claim 1, further comprising outlets for the waste fluid and for the permeate.

7. The cap of claim 1, wherein the waste fluid chamber comprises two interconnected segments.

8. The cap of claim 1, further comprising a waste fluid flange that extends along an inside wall of a filtration housing to inhibit flow of feed fluid.
